(19) United States
(12) Patent Application Publication
(10) Pub. No.: US 2006/0125783 A1
(43) Pub. Date: Jun. 15, 2006

(54) DISPLAY DEVICE WITH DETACHABLE HOUSING

(76) Inventors: Kuan-Hong Hsieh, Shenzhen (CN); Bing Li, Shenzhen (CN); Zai-An Pan, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,429

(22) Filed: Oct. 18, 2005

(30) Foreign Application Priority Data
Dec. 10, 2004 (TW) 093138297

(51) Int. Cl. G09G 5/00; H04N 5/64

(52) U.S. Cl. 345/156; 348/839

(57) ABSTRACT

A display device includes a main body, an interface unit, and a detachable housing. The interface unit interconnects the detachable housing with the main body. The detachable housing includes an on screen display (OSD) unit for storing a plurality of OSD data, and a command input unit for generating command signals in response to operations of a user. The main body receives the command signals through the interface unit, identifies the command signals, and if required, performing predetermined functions to obtain OSD data from the OSD unit through the interface unit, to display an OSD menu corresponding to the obtained OSD data, and adjust any parameters of the OSD menu according to the corresponding command signals.

### FIELD OF THE INVENTION

The present invention relates to a display device with a detachable housing that can be conveniently replaced if need be.

### DESCRIPTION OF RELATED ART

A typical electronic display device such as a TV or a computer monitor (e.g., an LCD) includes a main body and a housing. For each type of display device, such as LCDs, typically most of the components therein are the same. Some differences may include the contents of an on screen display (OSD) unit, and the structures of a command input unit. Traditionally, the OSD unit and the command input unit are all included in the main body, with the housing functioning only as a cover for the main body.

Recently, with the rapid increase in the number of computer users, the demand for individually unique OSD menus and command input units has significantly increased. For example, some users prefer knobs on a command input unit, whereas other users prefer keys or touch pads on the command input unit. Further, some users prefer fewer keys on a smaller command input unit, whereas other users prefer more keys on a more comprehensive command input unit. However, when the OSD unit and the command input unit are contained in the main body of the LCD, a manufacturer of LCDs has to configure an entirely unique LCD for each type of different OSD unit. Each time a new type of OSD unit is to be manufactured, time consuming and expensive redesigning and retooling are required.

There are a large number of display devices and housing means available in the market. For example, U.S. Pat. No. 6,339,453 issued on Jan. 15, 2002 and entitled “Television System Having Replaceable Graphics User Interface Architecture” provides a television and an external media module. The television includes a television control unit capable of generating a control signal, an apparatus for receiving a video signal, a media controller for generating a graphics signal, and a display unit for displaying either the video signal or a combined video and graphics signal. The external media module, external to the television, is connectable via an interface with the media controller, and implements a graphic on-screen display application in accordance with the television control signal. However, in order to change the type of the command input unit, e.g., knob, key, or touch pad, and/or change the number of knobs, keys, or touch pads, the entire display device needs to be redesigned.

Therefore, a heretofore unaddressed need exists in the industry to overcome the aforementioned deficiencies and inadequacies.

### SUMMARY OF INVENTION

The present invention provides a display device having a detachable housing, the detachable housing including an on screen display (OSD) unit and a command input unit. As a result, efficient large-scale production for like components of the display device is possible, with only the production of the detachable housing varying according to need.

A display device includes a main body, an interface unit, and a detachable housing. The interface unit interconnects the detachable housing with the main body. The detachable housing includes an on screen display (OSD) unit for storing a plurality of OSD data, and a command input unit for generating command signals in response to operations of a user. The main body receives the command signals through the interface unit, identifies the command signals, and if required, performs predetermined functions to obtain OSD data from the OSD unit through the interface unit, to display an OSD menu corresponding to the obtained OSD data, and to adjust any parameters in the OSD menu according to one or more corresponding command signals.

The main body includes a processing unit and a memory. The processing unit controls the display of an OSD menu and adjusts any of the parameters in the OSD menu according to the corresponding command signals received from the command input unit. The memory stores a control program run by the processing unit. The control program includes a plurality of subprograms for performing the predetermined functions. The predetermined functions mainly include turning on the display device, turning off the display device, and adjusting parameters of the display device.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a block diagram of hardware infrastructure of a liquid crystal display (LCD) with a detachable housing in accordance with a first preferred embodiment of the present invention.

FIG. 2 is a flowchart of a method for adjusting the parameters of the LCD of FIG. 1.

FIG. 3 is a block diagram of hardware infrastructure of a CRT (cathode ray tube) TV set with a detachable housing in accordance with a second preferred embodiment of the present invention.

FIG. 4 is a flowchart of a method for adjusting parameters of the CRT TV set of FIG. 3.

### DETAILED DESCRIPTION

The preferred embodiments of the present invention each disclose a display device with a detachable housing. The display device may be, for example, a cathode ray tube (CRT) monitor, a liquid crystal display (LCD), a CRT TV set, a liquid crystal TV set, or another similar kind of display device. For simplicity, the preferred embodiments described hereinbelow relate to an LCD and a CRT TV set. However, the present invention should not be construed as being limited to the embodiments set forth herein. The following detailed description of the embodiments is made with reference to the attached drawings.

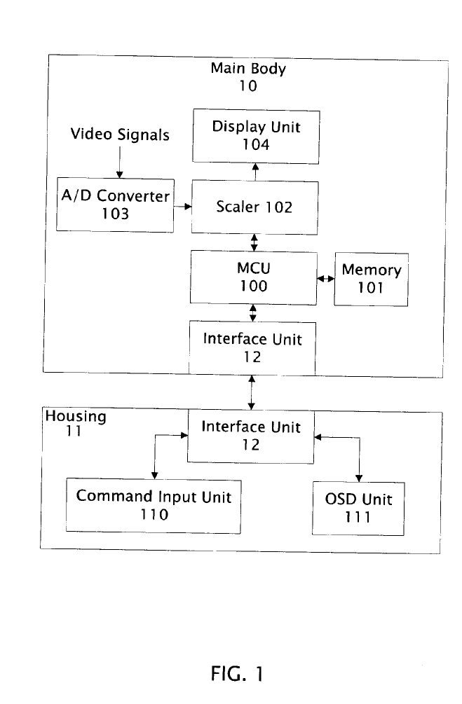

FIG. 1 is a block diagram of hardware infrastructure of an LCD in accordance with a first preferred embodiment of the present invention. The LCD includes a main body 10, a housing 11, and an interface unit 12. The interface unit 12 may be a display data channel (DDC), a universal serial bus (USB), a small computer system interface (SCSI), or the like. The interface unit 12 electrically interconnects the housing 11 and the main body 10. The main body 10 includes a micro-programmed control unit (MCU) 100, a memory 101, a scaler 102, an analog/digital (A/D) converter 103, and a display unit 104. The housing 11 includes a command input unit 110, and an on-screen display (OSD) unit 111.

The command input unit 110 generates and sends command signals in response to operations of a user. The operations of the user may include an instruction for turning on the LCD, turning off the LCD, and adjusting any of various parameters of the LCD. The parameters of the LCD mainly include volume level, color levels, brightness, contrast, vertical position, horizontal position, and so on. The OSD unit 111 stores a plurality of OSD data. When the user operates the command input unit 110 to adjust the parameters of the LCD, the scaler 102 obtains corresponding OSD data from the OSD unit 111 and generates a command signal for adjusting the parameters of the LCD under the control of the MCU 100. The memory 101 stores a control program run by the MCU 100. The control program includes a plurality of subprograms for turning on the LCD, turning off the LCD, and adjusting the parameters of the LCD.

The A/D converter 103 converts video signals from a computer (not shown) into digital signals, and then transmits the digital signals to the scaler 102. The scaler 102 transmits the digital signals to the display unit 104. Moreover, the scaler 102 obtains corresponding OSD data from the OSD unit 111 in response to the command signals for adjusting the parameters of the LCD, overlaps the digital signals and the OSD data to generate overlapped video signals, and transmits the overlapped video signals to the display unit 104 for display. This is done when the user initially operates the command input unit 110 to adjust any of the parameters of the LCD. Thereupon, the display unit 104 displays an overlapped image, including a video image and an OSD menu, according to the overlapped video signals received from the scaler 102. Subsequently, the scaler 102 adjusts any of the parameters of the LCD according to corresponding command signals received from the command input unit 110. Such command signals are generated by the initial operation of the command input unit 110 by the user, and/or by subsequent operation of the command input unit 110 by the user after the OSD menu is displayed. For example, if a command signal for adjusting the color levels is received, the scaler 102 adjusts the color levels so as to enhance the quality of the image on the display screen.

The housing 11 of the above-described embodiment includes the command input unit 110 and the OSD unit 111. As a result, efficient large-scale production for the components of a display device is possible, with only the production of the housing 11 varying according to need.

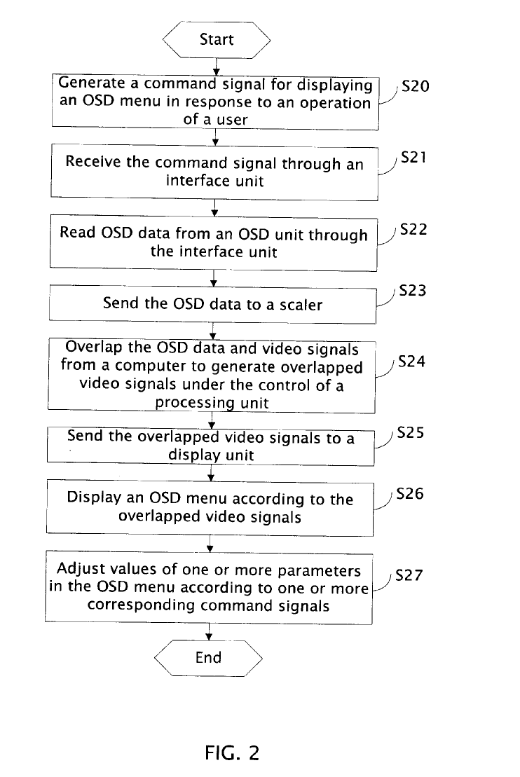

FIG. 2 is a flowchart of a method for adjusting the parameters of an LCD. In step S20, the command input unit 110 generates a command signal for displaying an OSD menu in response to a corresponding operation of a user. In step S21, the scaler 102 receives the command signal through the interface unit 12. In step S22, the MCU 100 executes a corresponding subprogram to read OSD data from the OSD unit 111. In step S23, the MCU 100 sends the OSD data to the scaler 102. In step S24, the scaler 102 overlaps the OSD data and the video signals from the computer to generate overlapped video signals under the control of the MCU 100. In step S25, the scaler 102 sends the overlapped video signals to the display unit 104. In step S26, the display unit 104 displays images including video images and an OSD menu according to the overlapped video signals. In step S27, the scaler 102 adjusts values of one or more parameters (e.g., volume level, color levels, brightness, contrast, vertical position, horizontal position, and so on) in the OSD menu, according to command signals received from the command input unit 110. Thereupon, the procedure is finished.

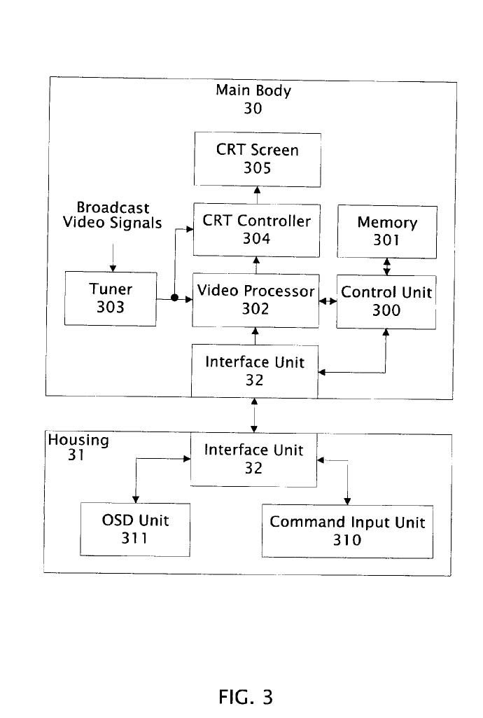

FIG. 3 is a block diagram of hardware infrastructure of a CRT TV set in accordance with a second preferred embodiment of the present invention. The CRT TV set includes a main body 30, a housing 31, and an interface unit 32. The interface unit 32 may be a display data channel (DDC), a universal serial bus (USB), a small computer system interface (SCSI), or the like. The interface unit 32 electrically interconnects the housing 31 and the main body 30. The main body 30 includes a control unit 300, a memory 301, a video processor 302, a tuner 303, a CRT controller 304, and a CRT screen 305. The housing 31 includes a command input unit 310, and an on-screen display (OSD) unit 311.

The command input unit 310 generates and sends command signals in response to operations of a user. The operations of the user may include turning on the CRT TV set, turning off the CRT TV set, and adjusting any of various parameters of the CRT TV set. The parameters of the CRT TV set mainly include volume level, color levels, brightness, broadcasting channels, and so on. The OSD unit 311 stores a plurality of OSD data. When the user operates the command input unit 310 to adjust the parameters of the CRT TV set, the video processor 302 obtains corresponding OSD data from the OSD unit 311 under the control of the control unit 300 in response to the command signals for adjusting the parameters of the CRT TV set. The memory 301 stores a control program run by the control unit 300. The control program includes a plurality of subprograms for turning on the CRT TV set, turning off the CRT TV set, and adjusting the parameters of the CRT TV set.

The tuner 303 receives broadcast video signals from an antenna (not shown), and transmits the broadcast video signals to the video processor 302. The broadcast video signals include chrominance signals, luminance signals, and synchronization signals. The video processor 302 demodulates the broadcast video signals into the chrominance signals, luminance signals, and synchronization signals, and transmits the demodulated broadcast video signals to the CRT controller 304. Moreover, the video processor 302 overlaps the demodulated broadcast video signals with OSD data from the OSD unit 311 to generate overlapped video signals. The video processor 302 then transmits the overlapped video signals and the synchronization signals to the CRT controller 304. When detecting the synchronization signals, the CRT controller 304 displays an overlapped image on the CRT screen 305, according to the overlapped video signals received from the video processor 302. The overlapped image includes a broadcast video image and an OSD menu. The video processor 302 adjusts any of various parameters of the CRT TV set according to a corresponding command signal received, under the control of the control unit 300. Such command signals are generated by initial operation of the command input unit 310 by the user to adjust any of the parameters of the CRT TV set, and/or by subsequent operation of the command input unit 310 by the user after the OSD menu is displayed. The parameters may include volume level, color levels, broadcasting channels, and so on.

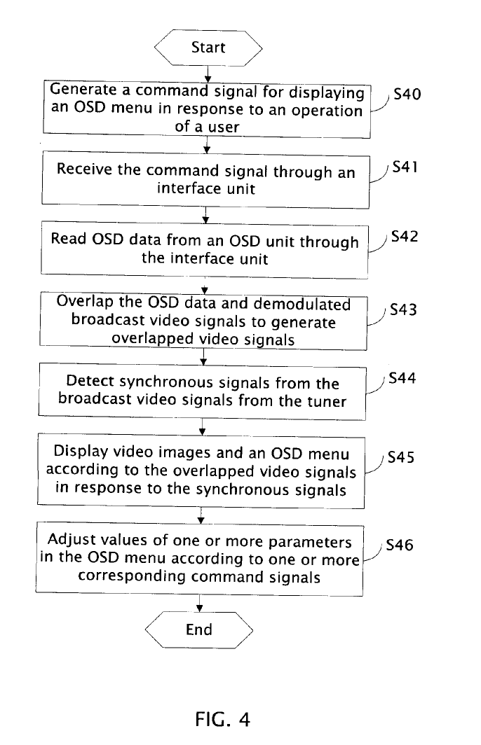

FIG. 4 is a flowchart of the method for adjusting the parameters of the CRT TV set. In step S40, the command input unit 310 generates a command signal for displaying an OSD menu in response to a corresponding operation of a user. In step S41, the video processor 302 receives the command signal through the interface unit 32. In step S42, the video processor 302 executes a corresponding subprogram to read OSD data from the OSD unit 311, under the control of the control unit 300. In step S43, the video processor 302 overlaps the OSD data and the demodulated broadcast video signals to generate overlapped video signals. In step S44, the CRT controller 304 detects synchronous signals in the broadcast video signals from the tuner 303. In step S45, the CRT controller 304 displays images on the CRT screen 305 according to the overlapped video signals in response to the synchronous signals. The images include video images and an OSD menu. In step S46, the video processor 302 adjusts the values of one or more parameters (e.g., volume levels, color levels, broadcasting channels, and so on) in the OSD menu, according to the command signal from the command input unit 310. Thereupon, the procedure is finished.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A display device comprising a main body, an interface unit, and a detachable housing, wherein:
the interface unit interconnects the detachable housing with the main body;
the detachable housing comprises an on screen display (OSD) unit for storing a plurality of OSD data, and a command input unit for generating command signals in response to operations of a user; and
the main body is for receiving the command signals through the interface unit, identifying the command signals, and if required, performing predetermined functions to obtain OSD data from the OSD unit through the interface unit, to display an OSD menu corresponding to the obtained OSD data, and adjust any parameters in the OSD menu according to corresponding one or more command signals.

2. The display device according to claim 1, wherein the main body comprises a processing unit for controlling the display of the OSD menu in order to adjust any of the parameters in the OSD menu according to corresponding command signals received from the command input unit.

3. The display device according to claim 1, wherein the main body comprises a memory for storing a control program run by the processing unit, the control program comprising a plurality of subprograms for performing the predetermined functions, the predetermined functions comprising turning on the display device, turning off the display device, and adjusting parameters of the display device.

4. The display device according to claim 1, wherein the main body comprises a display module for displaying the OSD menu.

5. A detachable housing for a display device, the display device having a main body, the detachable housing interconnecting with the main body by way of an interface unit, the detachable housing comprising:
an on-screen display (OSD) unit for storing a plurality of OSD data; and
a command input unit for generating command signals in response to operations of a user;
wherein the main body is for receiving the command signals through the interface unit, identifying the command signals, and if required, performing predetermined functions to obtain OSD data from the OSD unit through the interface unit, to display an OSD menu corresponding to the obtained OSD data, and adjust any parameters in the OSD menu according to corresponding one or more command signals.

6. The detachable housing according to claim 5, wherein the command signals comprise signals for turning on the display device, turning off the display device, displaying the OSD menu, and adjusting parameters of the display device.
